(19) United States
(12) Patent Application Publication
(10) Pub. No.: US 2013/0167782 A1
(43) Pub. Date: Jul. 4, 2013

(54) Pet Leash for Multiple Users

(71) Applicant: Kathryn R. Poch, Denver, CO (US)

(72) Inventor: Kathryn R. Poch, Denver, CO (US)

(21) Appl. No.: 13/776,227

(22) Filed: Feb. 25, 2013

Related U.S. Application Data
(63) Continuation-in-part of application No. 13/434,226, filed on Mar. 29, 2012.
(60) Provisional application No. 61/516,231, filed on Mar. 31, 2011.

(51) Int. Cl. A01K 27/00

(52) U.S. Cl. CPC A01K 27/003
USPC 119/795

(57) ABSTRACT

A leash system for restraining an animal is provided. The system comprises a primary leash and a secondary leash, the secondary leash being selectively securable to a portion of the primary leash and translatable thereon. The system may be controlled or operated by a single user in a first arrangement, and at least two users in a second arrangement.

The present application is a Continuation-in-Part of U.S. patent application Ser. No. 13/434,226, filed Mar. 29, 2012, which claims the benefit of priority from U.S. Provisional Patent Application No. 61/516,231, filed Mar. 31, 2011, the entire disclosures of which are hereby incorporated by reference in their entireties.

### FIELD OF THE INVENTION

The present disclosure relates generally to dog leashes and restraint devices. More specifically, the present disclosure relates to dog leashes comprising features to selectively allow one or more individuals to walk, control, or restrain an animal in a mobile, safe and secure manner.

### BACKGROUND

Various devices for walking, controlling, or restraining animals fail to provide various benefits of the present disclosure. For example, U.S. Pat. No. D539,489 to Scott, which is hereby incorporated by reference in its entirety, discloses a two-handled leash that is devoid of adjustable or translatable features. Similarly, U.S. Pat. Nos. 5,363,810 to Kraus and 5,649,504 to Culp, which are hereby incorporated by reference in their entireties, disclose animal tether systems with two handles that are similarly devoid of various novel features of the present disclosure. U.S. Pat. Nos. 6,237,539 to Sporn and 4,879,972 to Crowe et al., which are also hereby incorporated by reference in their entireties, further fail to disclose various features of the present disclosure.

### SUMMARY OF THE INVENTION

Accordingly, there has been a long-felt and unmet need to provide a dog leash capable of being grasped or controlled by a plurality of users and further securing or controlling an animal.

In various embodiments, the present disclosure provides for such a device that allows for safe, convenient, and controlled manipulation of an animal by either one or a plurality of users. Leash systems of the present disclosure provide numerous benefits over known systems. In particular, the present disclosure contemplates features that allow or facilitate a first user to have primary control of a dog or animal and a second user to have an additional degree of control of the same animal. The second user may, but need not necessarily be, a child who wishes to engage in dog-walking activities. Various features and benefits of the present disclosure allow for such a second user to become engaged, without putting that user, the animal, or the first user in danger.

The Summary of the Invention is neither intended nor should it be construed as being representative of the full extent and scope of the present disclosure. The present disclosure is set forth in various levels of detail in the Summary of the Invention as well as in the attached drawings and the Detailed Description of the Invention and no limitation as to the scope of the present disclosure is intended by either the inclusion or non-inclusion of elements, components, etc. in this Summary of the Invention. Additional aspects of the present disclosure will become more readily apparent from the Detailed Description, particularly when taken together with the drawings.

In one embodiment, a dog leash is provided comprising two handles adapted for use by two people to walk a dog or pet. It is contemplated that the two handles of leashes according to various embodiments are adapted for use with an adult user and a child user, but it will be expressly recognized that the present disclosure is not so limited.

In preferred embodiments, a leash system is provided with a plurality of handles, with at least one handle operatively associated with a primary leash and at least one handle operatively associated with a secondary leash, wherein both the primary leash and secondary leash are in force-transmitting communication with a distal end of the leash system.

In one embodiment, a first end of the secondary leash is translatable along a designated length or area of the primary leash. The secondary leash is thus free to translate along at least a portion of a length of the primary leash.

The secondary leash, in various embodiments, is further capable of rotating about a longitudinal axis of the primary leash, such that the secondary leash may be oriented in various positions with respect to the primary leash and can be handled by a user on various sides of the primary leash. Leash handles may be secured with a hook and loop closure, thus providing the ability to release from a user's grip, as may be desirable in various situations. Alternatively, one or more of the leash handles or loops is secured using a break-away feature or safety means. Such feature(s) include, but are not limited to, buckles, clasps, magnets and clips that withstand a predetermined tension and/or torsion load and wherein upon such a load exceeds the predetermined value the feature separates or breaks away, thus opening the handle or loop and providing advanced safety features. Break-away features or safety means of the present invention are preferably separable in a non-destructive manner. That is, in preferred embodiments, the break-away features or safety means are capable of being re-attached or re-assembled subsequent to breakage or separation.

In one embodiment, a leash system for use in the control of an animal is provided, the system comprising a first leash member and a second leash member, both members having a fixed or predetermined length. The first end of the first leash member and the first end of the second leash member each comprise a handle portion, and the second end of the first leash member comprises means for selectively securing the first leash member to an animal. The second end of the second leash member is slidably interconnected to the first leash member, such that the second end of the second leash member is translatable along at least a portion of the first leash member. The first leash member, in certain embodiments, comprises first and second delimiting members spaced apart along the predetermined length of the first leash member and between which a path of travel of the second end of the second leash member is defined.

In various embodiments, elastic or expandable features are provided such that at least a portion of a length of the system is expandable. Expandable features of the present disclosure for use within the system comprise, for example, features disclosed in U.S. Pat. Nos. 7,610,880 to Lord, 7,909,004 to Thompson et al., 6,886,499 to Meissner, 6,904,872 to Muller, all of which are hereby incorporated by reference in their entireties, as well as elastic features capable of expanding to a certain length, such as features of “bungee leashes.”

These and other advantages will be apparent from the disclosure of the invention(s) contained herein. The above-described embodiments, objectives, and configurations are neither complete nor exhaustive. As will be appreciated, other embodiments of the invention are possible using, alone or in combination, one or more of the features set forth above or described in detail below. Further, the summary of the invention is neither intended nor should it be construed as being representative of the full extent and scope of the present invention. The present invention is set forth in various levels of detail in the summary of the invention, as well as, in the attached drawings and the detailed description of the invention and no limitation as to the scope of the present invention is intended to either the inclusion or non-inclusion of elements, components, etc. in this summary of the invention. Additional aspects of the present invention will become more readily apparent from the detailed description, particularly when taken together with the drawings.

### BRIEF DESCRIPTION OF THE DRAWINGS

Those of skill in the art will recognize that the following description is merely illustrative of the principles of the disclosure, which may be applied in various ways to provide many different alternative embodiments. This description is made for illustrating the general principles of the teachings of this disclosure invention and is not meant to limit the inventive concepts disclosed herein.

The accompanying drawings, which are incorporated in and constitute a part of the specification, illustrate embodiments of the disclosure and together with the general description of the disclosure given above and the detailed description of the drawings given below, serve to explain the principles of the disclosures.

It should be understood that the drawings are not necessarily to scale. In certain instances, details that are not necessary for an understanding of the disclosure or that render other details difficult to perceive may have been omitted. It should be understood, of course, that the disclosure is not necessarily limited to the particular embodiments illustrated herein.

FIG. 1 is a perspective view of a leash system according to one embodiment;

FIG. 2 is a detailed view of one portion of a leash system according to one embodiment;

FIG. 3 is a detailed view of one portion of a leash system according to one embodiment;

FIG. 4A is a detailed view of one portion of a leash system according to one embodiment;

FIG. 4B is a detailed view of one portion of a leash system according to one embodiment;

FIG. 4C is a detailed elevation view of one portion of a leash system according to one embodiment;

FIG. 5 is a detailed view of one portion of a leash system according to one embodiment;

FIG. 6A is a detailed view of one portion of a leash system according to one embodiment;

FIG. 6B is a detailed view of one portion of a leash system according to one embodiment; and

FIG. 6C is a detailed elevation view of one portion of a leash system according to one embodiment.

### DETAILED DESCRIPTION

The present invention has significant benefits across a broad spectrum of endeavors. To acquaint persons skilled in the pertinent arts most closely related to the present invention, a preferred embodiment of the method that illustrates the best mode now contemplated for putting the invention into practice is described herein by, and with reference to, the annexed drawings that form a part of the specification. The exemplary method is described in detail without attempting to describe all of the various forms and modifications in which the invention might be embodied. As such, the embodiments described herein are illustrative, and as will become apparent to those skilled in the arts, can be modified in numerous ways within the scope and spirit of the invention.

The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

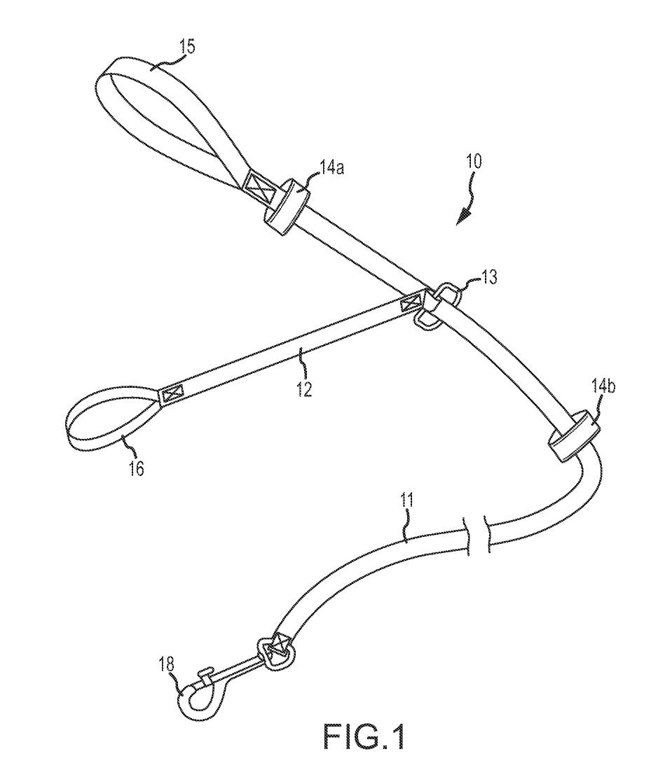

Referring now to FIG. 1, a leash system 10 according to one embodiment of the present disclosure is provided. It should be understood that the drawings are not necessarily to scale. In certain instances, details that are not necessary for an understanding of the invention or that render other details difficult to perceive may have been omitted from these drawings. It should be understood, of course, that the invention is not limited to the particular embodiments illustrated in the drawings.

FIG. 1 is a perspective view of a leash system 10 according to one embodiment. The system 10 comprises a first or primary leash member 11 and a secondary leash member 12. Each of the primary and secondary leash members comprise a handle portion 15, 16 for grasping by a user at a first or proximal end of the leash member. The embodiment of FIG. 1 depicts handle portions 15, 16 generally constructed as loop members, but handle portions 15, 16 may be provided in any number of arrangements. A second end of the first leash member 11, located generally distal from the first end, comprises means for selectively securing the system to an animal (not shown). Means for selectively securing the system comprise, for example, a clasping device 18 secured to the second end of the primary leash 11 by passing the second end through an opening on the clasping device 18 and secured back onto itself, preferably by stitching.

A second end of the secondary leash 12 is slidably secured to the primary leash 11 by a sliding mechanism 13. In one embodiment, sliding mechanism 13 comprises a substantially rigid member, such as a metal or plastic loop to which the second end of the secondary leash 12 is passed through and secured back onto itself, preferably by stitching. A wide array of sliding mechanisms is contemplated for use with the system. Such sliding mechanisms 13 include, but are not limited to, closed loops of various construction (e.g. metal loops, looped portions of the leash end, etc.), carabineers, devises, self-locking hooks, slip hooks, chain link portions, and various similar devices.

In a preferred embodiment, the sliding mechanism 13 surrounds the primary leash 11. The sliding mechanism 13, and therefore the secondary leash 12, is kept on the primary leash 11 between two delimiting members 14a, 14b. Delimiting members 14a, 14b are secured to the first leash member 11, such as by stitching the delimiting members 14a, 14b directly to the leash member 11. Delimiting members 14a, 14b operate to limit a path of travel for the sliding mechanism 13 and secondary leash member 12 by preventing the sliding mechanism 13 from travelling past certain points. For example, the first delimiting member 14a, in one embodiment, is provided proximal the first end of the primary leash member 11 such that the sliding mechanism 13 is prevented from traveling into the handle 15 or contacting and potentially injuring a user's hand. The second delimiting member 14b is provided generally proximal to the second end of the first leash member 11, such that the sliding mechanism 13 is bounded by the second delimiting member 14b in a manner that prevents the secondary leash member from contacting or interfering with the distal end of the primary leash member and/or a dog associated with the system. The second delimiting member 14b thus increases the safety of the device by reducing risks of entanglement and inadvertent release of a dog, for example. The second delimiting member 14b, in various embodiments, further ensures that the primary leash member 11 operates as a primary force-transmitting device that hosts or receives the secondary leash member 12 such that a substantial portion of forces applied by a dog are directed to a user of the primary leash member 11 as opposed to a user of the secondary leash member.

FIG. 1 depicts the delimiting members 14a, 14b as comprising portions stitched onto a first leash member 11, and thus fixed in particular locations. In various alternative embodiments, however, delimiting members may be provided as selectively adjustable members such that they may be moved along a length of the leash 11 and selectively secured.

In one embodiment, the first leash member 11 is provided with one or more elongate interior channels having a predetermined length, such that secondary leash member 12 may be connected to the channel and slidable therein.

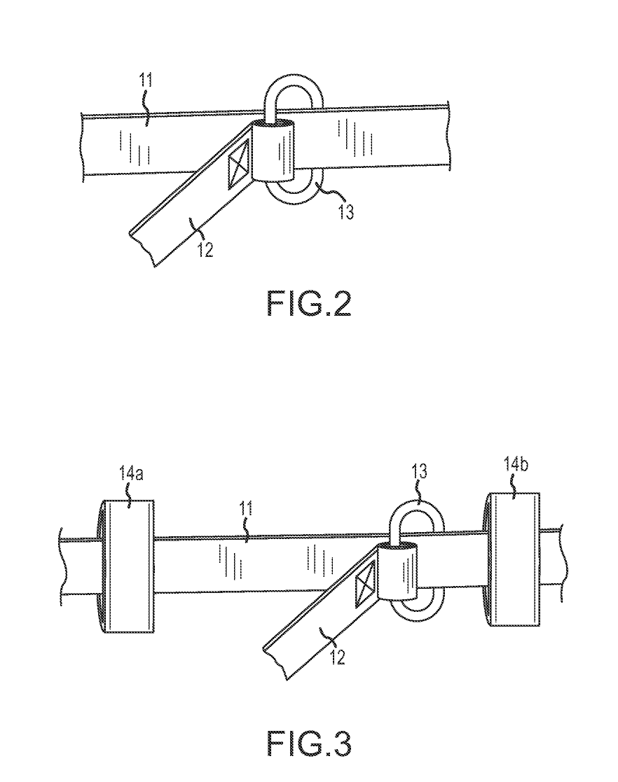

FIG. 2 is a detailed view of a sliding mechanism 13 disposed around a primary leash member 11. The secondary leash 12 is attached to the sliding mechanism 13 by looping a section of the secondary leash 12 through the sliding mechanism 13 and secured back onto itself, preferably by stitching. The sliding mechanism 13 also surrounds the primary leash 11. In various embodiments, leash members comprise suitable materials for withstanding tension forces known to exist in walking or restraining animals. Such materials include, for example, nylon, ballistic nylon, hemp, leather, and various similar materials as will be recognized. In preferred embodiments, the leash material provides sufficient resistance to tensile forces, is pliable or flexible in at least one direction, and does not significantly limit or prevent the sliding mechanism 13 from sliding along a length of the primary leash 11.

FIG. 3 is a detailed view of delimiting members 14a, 14b in accordance with one embodiment. As shown, delimiting members 14a, 14b comprise a length of material wrapped around and/or stitched to the primary leash member 11. In preferred embodiments, delimiting members 14a, 14b comprise at least a height or a width that is larger than a corresponding dimension of the sliding mechanism 13 such that the sliding mechanism 13 is not capable of translating past or over the delimiting members 14a, 14b.

In various alternative embodiments, the delimiting members 14a, 14b comprise various structures and shapes. It will be expressly recognized that delimiting members 14a, 14b are not limited to any particular structure, and may comprise any number of features for accomplishing the objective of generally restraining or limiting the sliding mechanism 13 and associated secondary leash 12 to a portion of the primary leash's 11 length. In one embodiment, the delimiting members 14a, 14b comprise a section material of the same composition as the leash members, the members 14a, 14b being secured to the primary leash 11 in a substantially transverse manner. In one embodiment, the delimiting members 14a, 14b comprise a support structure, such as a plastic insert to increase rigidity of the member.

It will be expressly understood that the delimiting members 14a, 14b may be of various sizes. In various embodiments, the size of the delimiting members 14a, 14b are determined by the size of the sliding mechanism. Delimiting members 14a, 14b, in alternative embodiments, comprise protrusions fixed to the leash member 11, the protrusions being of various sizes and shapes including, but not limited to, hemispherical protrusions, planar protrusions, asymmetrical protrusions, conical protrusions, frustoconical protrusions, pin-like protrusions, knots, and various similar features capable of obstructing movement of the sliding mechanism 13.

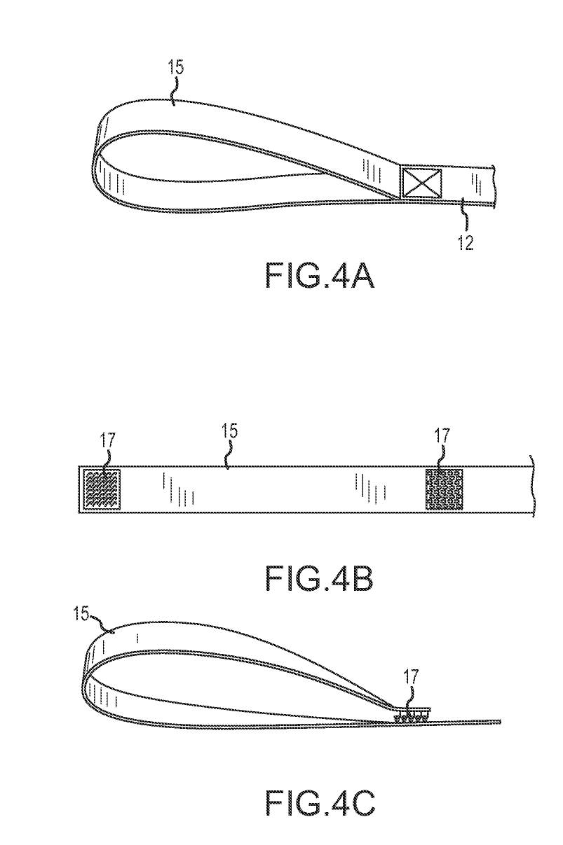

FIG. 4A is a detailed view of a handle 15 according to one embodiment. The handle 15 as provided in FIG. 4 may be provided on either or both of the primary leash member and the secondary leash member. The handle portion 15 is formed by folding a section of the leash member onto itself, thus creating a loop. To secure the loop and create a handle 15, the first end of the primary leash 11 is secured onto itself, preferably by sewing. Alternatively, the loop portion may be formed or closed with a hook and loop closure 17. Embodiments comprising the hook and loop closure system 17 may be particularly desirable for use in connection with secondary leash members, wherein children are the intended users of the secondary leash portion. Such a system provides enhanced safety in that the handle may break away if a sudden or unexpected force is applied. In such a circumstance, the primary leash member 11 would provide primary restraint such that an adult user could still control an associated animal. In one preferred embodiment, a leash system 10 is provided wherein a handle portion 15 of a first leash member 11 comprises a loop formed by stitching or sewing and a second handle portion 16 of the secondary leash portion 12 comprises a selectively releasable handle portion 16 formed with a hook and loop closure 17.

FIG. 4B is a plan view of a handle portion 15 comprising a hook and loop closure system 17, the handle 15 being shown in an open or unattached position. FIG. 4C is an elevation view of the handle 15 the embodiment of FIG. 4B provided in a closed or connected position.

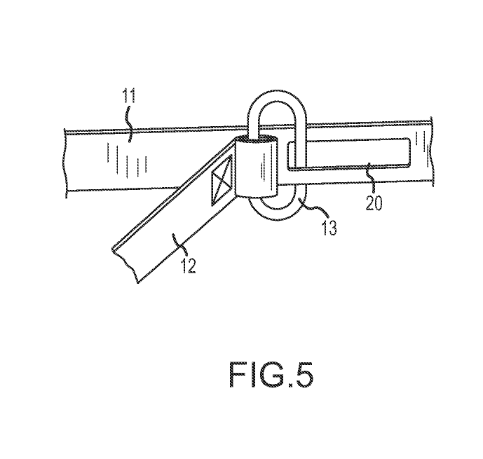

FIG. 5 is a detailed view of a portion of a leash system according to one embodiment. As shown, a primary leash member 11 comprises an aperture or channel 20 within which a sliding mechanism 13 may freely translate. Channel 20, in various embodiments, comprises a reinforced member, such as an elongate reinforced grommet feature to reduce wear on the leash 11. The sliding member 13 may comprise any mechanism shown and described herein and preferably comprises a selectively removable mechanism, such as a carabineer or similar device. Selectively removable devices provide the benefit of being able to remove the secondary leash member 12 from the system altogether when desired. FIG. 5 depicts the channel 20 as being of a certain length, but the present disclosure is not so limited. Channels may be comprised of any number of geometries. Preferably, however, the channel 20 is not so long or wide as to impede basic leash functions and flexibility. In various embodiments, any number of channels 20 may be provided along the length of the primary leash member 20.

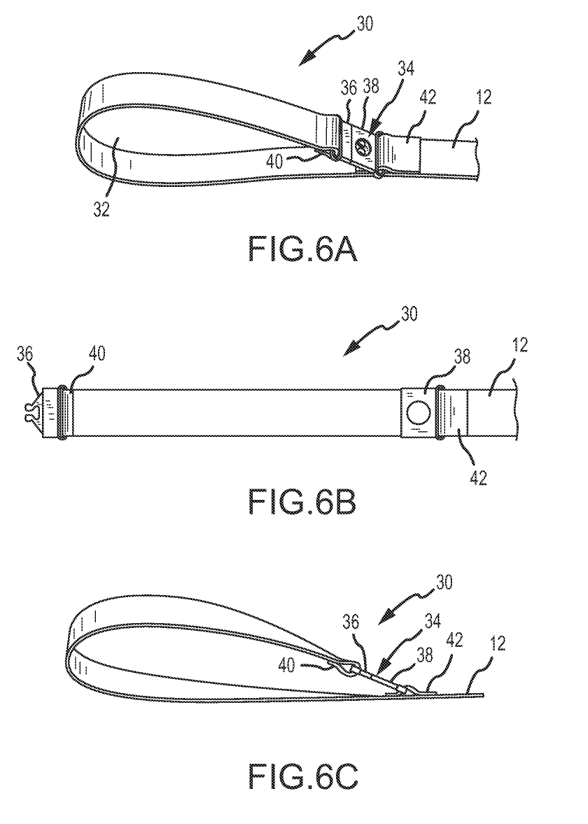

FIG. 6A is a detailed view of a handle 30 according to one embodiment. The handle 30 as provided in FIG. 6A may be provided on either or both of the primary leash member and the secondary leash member. The handle portion 30 is formed by folding a section of the leash member onto itself, thus creating a loop 32. To secure the loop and create a handle 30, the first end of a leash 12 may be secured onto itself, such as by sewing. Alternatively, the loop portion 30 is formed or closed with a clip or buckle device 34. Embodiments comprising a clip or buckle device 34 may be particularly desirable for use in connection with secondary leash members, wherein children are the intended users of the secondary leash portion. Such a system provides enhanced safety in that the handle may break away if a sudden or unexpected force is applied. Additionally, the clip or buckle 34 provides easy-release features. The primary leash member 11 (not shown) preferably provides primary restraint such that an adult user can control an associated animal via primary leash member 11. In one embodiment, a leash system is provided wherein a handle portion of a first leash member 11 comprises a loop formed by stitching or sewing and a second handle portion 30 of the secondary leash portion 12 comprises a selectively releasable handle portion formed with a buckle or clip closure 34.

FIG. 6B is a plan view of a handle portion 30 comprising a buckle or clip closure, the handle 30 being shown in an open or unattached position. FIG. 6C is an elevation view of the handle 30 the embodiment of FIG. 6B provided in a closed or connected position. As shown, a male portion of the buckle 36 is attached to the distal end of the secondary leash 12 by looping a section of the secondary leash 12 through the male half of the buckle 36 and securing it back onto itself, preferably by stitching 40. A female portion of the buckle 38 is attached to an additional piece of material 42, preferably the leash material, by looping a section of the additional piece of material 42 through the female half of the buckle 38 and securing it back onto itself, preferably by stitching. This additional piece of material 42 with the attached female half of the buckle 38 is then secured to the secondary leash 12, preferably by stitching, at a given distance away from the distal end. Connecting the male 36 and female 38 halves of the buckle 34 together creates a looped handle for the secondary leash 12. The provided buckle 34 preferably comprises a break-away feature that releases under the application of a predetermined tension load.

In various embodiments as shown and described herein, leash members may be of various lengths. While preferred embodiments contemplate providing a primary leash member of between approximately three feet and approximately ten feet, and a secondary leash member of between approximately one foot and approximately four feet, various modifications and different lengths of leash members, both within and outside of such ranges are contemplated as within the scope and spirit of the present disclosure.

While various embodiments of the present invention have been described in detail, it is apparent that modifications and alterations of those embodiments will occur to those skilled in the art. However, it is to be expressly understood that such modifications and alterations are within the scope and spirit of the present disclosure. Further, the invention(s) described herein are capable of other embodiments and of being practiced or of being carried out in various ways. In addition, it is to be understood that the phraseology and terminology used herein is for the purposes of description and should not be regarded as limiting. The use of “including,” “comprising,” or “adding” and variations thereof herein are meant to encompass the items listed thereafter and equivalents thereof, as well as, additional items.

What is claimed is:

1. A leash system for use in the control of an animal, comprising:
a first leash member having a first end, a second end, and a predetermined length therebetween;
a second leash member having a first end, a second end, and a predetermined length therebetween;
the first end of the first leash member and the first end of the second leash member each comprising a handle portion;
the second end of the first leash comprising means for selectively securing the first leash member to an animal;
the second end of the second leash member being slidably interconnected to said first leash member;
the first end of the second leash member comprising a handle portion comprising a loop, the loop having a closure means for selectively opening and closing the loop; and
the first leash member comprising first and second delimiting members spaced apart along the predetermined length of the first leash member and between which a path of travel of the second end of the second leash member is defined.

2. The leash system of claim 1, wherein the closure means comprises at least one of a hook-and-loop closure, a clip, and a buckle.

3. The leash system of claim 1, wherein the handle portion of the first leash member comprises a closed loop comprising stitching.

4. The leash system of claim 1, wherein the means for selectively securing comprises at least one of a clip, swivel hook, swivel snap, carabineer, adjustable loop, and a clevis.

5. The leash system of claim 1, wherein the second end of the second leash member is selectively interconnected to said first leash member.

6. The leash system of claim 1, wherein first and second delimiting members comprise laterally extending members comprising substantially the same material as the first leash member.

7. The leash system of claim 1, wherein the second end of the second leash member is slidably interconnected to the first leash member by a substantially rigid loop, the substantially rigid loop comprising a length that is less than a length of the first and second delimiting members such that the loop is confined by the first and second delimiting members.

8. A leash for use in the control of a dog, comprising:
a first leash member having a first end, a second end, and a predetermined length therebetween;
a second leash member having a first end, a second end, and a predetermined length therebetween;
the first end of the first leash member and the first end of the second leash member each comprising a handle portion;
the second end of the first leash member comprising means for selectively securing the first leash member to an animal;
the first end of the second leash member comprising a handle portion comprising a loop, the loop having a closure means for selectively opening and closing the loop; and
the second end of the second leash member comprising a closed loop portion, the closed loop portion extending around the first leash member such that the second leash member is in force transmitting communication with the first leash member.

9. The leash system of claim 8, closure means comprises at least one of a hook-and-loop closure, a clip, and a buckle.

10. The leash system of claim 8, wherein the handle portion of the first leash member comprises a closed loop comprising stitching.

11. The leash system of claim 8, wherein the means for selectively securing comprises at least one of a clip, swivel hook, swivel snap, carabineer, adjustable loop, and a clevis.

12. The leash system of claim 8, wherein the closed loop portion of the second leash member is selectively removable to said first leash member.

13. The leash system of claim 8, further comprising at least one delimiting member provided along the length of the first leash member for limiting a movement of the second leash member.

14. The leash system of claim 13, wherein the second end of the second leash member is slidably interconnected to the first leash member by a substantially rigid loop, the substantially rigid loop comprising a length that is less than a length of the at least one delimiting member.

15. The leash system of claim 8, wherein at least one of the first leash member and the second leash member comprise elastic.

16. A dog leash for simultaneous use by more than one user, comprising:
a first member having a first end, a second end, and a length;
a second member having a first end, a second end, and a length;
a plurality of handle portions;
the first member comprising a distal end for securing to a dog;
the first end of the second member comprising a selectively securable loop portion; and
the second end of the second member interconnected to the first member and in force transmitting communication with the dog.

17. The dog leash of claim 16, wherein the second end of the second member is translatable along a portion of the length of the first member.

18. The dog leash of claim 16, wherein the length of the second member is shorter than the length of the first member.

19. The dog leash of claim 16, further comprising at least one delimiting member disposed on the first member.

20. The dog leash of claim 17, wherein the portion of the length of the first member is defined by two delimiting members interconnected to the first member.
